(19) United States
(12) Patent Application Publication
(10) Pub. No.: US 2026/0320528 A1
(43) Pub. Date: Oct. 15, 2026

(54) Mixed Risk Course of Action System and Method of Thereof

(71) Applicant: The United States of America as Represented by the Secretary of the Navy, Arlington, VA (US)

(72) Inventor: Harrison Christian Schramm, Pacific Grove, CA (US)

(21) Appl. No.: 19/464,076

(22) Filed: Jan. 29, 2026

Related U.S. Application Data
(60) Provisional application No. 63/765,865, filed on Mar. 3, 2025.

(51) Int. Cl. G06Q 10/0635

(52) U.S. Cl. CPC G06Q 10/0635

(57) ABSTRACT

A risk based shortest course of action generator comprising: a risk mix manager configured to identify and assess risks, wherein the risk mix manager provides options to a risk assessment engine; and the risk assessment engine is configured to accept one or more risk data and map source data inputs; wherein the risk assessment engine and the risk mix manager continuously update each other with risks and risk evaluations; wherein the risk assessment engine outputs defensible courses of action (COA).

### CROSS-REFERENCE TO RELATED APPLICATIONS

This Patent Application takes priority from U.S. Provisional Patent Application No. 63/765,865, filed on Mar. 3, 2025, titled A Mixed Course of Action System and Method Thereof, the contents of which are expressly incorporated herein by this reference as though set forth in their entirety and to which priority is claimed.

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to a system and method of optimization based on distance and risk as they relate to survivability. More specifically, the present disclosure relates to a mixed risk course of action system and method thereof.

### BACKGROUND

Generally, optimization problems are typically solved by creating graphs where vertices represent elements from a set of numbers, and edges connect pairs of elements that sum to a desired value, usually by analyzing additive structures within a set.

In mathematics, “graph theory used in additive math” refers to the application of graph theoretic concepts and techniques to solve problems in additive number theory, particularly within the field of “additive combinatorics,” where the focus is on studying the structure of sets of integers under addition, often leveraging the visual representation and analysis capabilities of graphs to identify patterns and prove theorems about sums of integers.

The most commonly used theorem for finding the shortest path is the principle behind Dijkstra's algorithm:

D=min(d(v), (d[u]+w(v, u))),

where d([v] is the current calculated shortest distance from a source node to node “v”, and (d[u]+w(v, u)) calculates the potential new shortest distance d(v) which allows one to find the shortest path between one vertex and all other vertices in a weighted graph, provided the edge weights are non-negative; essentially, it states that at each step, one should select the unvisited vertex with the smallest distance from the starting point to build the shortest path.

Edge weights are typically assigned a numerical value, a weight, to represent a metric such as distance, cost, or time between the connected vertices. Edges are lines or connections linking two “vertices,” representing the relationship between different points within the graph structure, which define how different nodes are connected within the network.

Typically, an optimized solution is an additive combinatory solution utilizing weighted edges. Weighted edges are an additive combinatory means, where the total weight of a path or subgraph is calculated by adding up the weights of all the individual edges included in that path or subgraph; meaning, the weights are combined through addition, and therefore “additive.”

Risk is typically a unitless parameter representing a probability or likelihood of an event occurring. Solutions to probabilities of events occurring simultaneously require multiplication to find the combined probability of independent events; essentially, multiplying the individual probabilities of each event to get the probability of all events occurring in sequence. Weighted edges found using multiplicative methods may not be trivially nor linearly combined with weighted edges found with additive combinatorial methods.

Therefore, a system and method are needed to determine the shortest path using a mix of risk and linear costs.

The background section is provided to reveal information believed by the applicant to be of possible relevance to the present technology. No admission is necessarily intended, nor should be construed, that any of the preceding information constitutes prior art against the present technology.

### SUMMARY

To minimize the limitations in the prior art, and to minimize other limitations that will become apparent upon reading and understanding the present specification, the present disclosure discloses a new and useful system for calculating mixed risk and generating a course of action.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem of determining the shortest path while maintaining acceptable survivability risk using unitless and multiplicative parameters in weighted graphs is solved by incorporating a convex and risk distance parameter to provide the shortest path based on acceptable risk.

One embodiment of a risk based shortest course of action generator comprising: a risk mix manager configured to identify and assess risks, wherein the risk mix manager provides options to a risk assessment engine; and the risk assessment engine being configured to accept risk data and map source data inputs; wherein a set of options are produced based at least in part on potential options; wherein the risk assessment engine and the risk mix manager continuously update each other with risks and risk evaluations; wherein the risk assessment engine outputs courses of action (COA). Wherein the risk assessment engine determines a risk-score distance for each COA as determined by:

COA_{RD}=λLD+(1+λ) κ (−ln(RD))

Where LD is a linear distance, RD is a risk distance, λ is a convexity parameter, 0≤λ≤1, and κ is the risk distance. Wherein each of the COA provides a different shortest distance based at least in part on a risk-score. Wherein each of the COA provides an increased distance based at least in part on a greater probability of survivability. The risk based shortest course of action generator further comprising breakpoints; wherein the breakpoints are based at least in part on risk and distance. Wherein the breakpoints are a course of action.

An alternate embodiment of the present disclosure may be a course of action generator comprising a non-transitory computer readable medium storing instruction for execution by a processor, wherein the instructions comprise: inputting, by wired and or wireless sources, risk data to be assessed; assessing, by a risk assessment engine, wherein the risk assessment engine identifies and assesses risks to a user and provides a quantified risk and a risk assessment to a risk manager for identification of additional risk; managing risk, by the risk mix manager, wherein the risk mix manager provides COA options to reduce risk; and generating, by the risk assessment engine, one or more COA based at least in part on risk, distance, and cost to the user. The course of action generator including estimating, by the risk assessment engine, a quantitative impact of the risk. The course of action generator including monitoring and reporting the quantitative risk. Wherein a probability and an impact are used to develop a risk-score. Wherein a high-risk score relates to a lower probability of survival at a lower cost. Wherein a low-risk score relates to a higher probability of survival at a higher cost. The course of action generator including breakpoints; wherein the one or more breakpoints are based at least in part on risk and distance. Wherein the breakpoints are a course of action.

An alternate embodiment of the present disclosure may be method of providing the shortest risk-based path comprising: inputting, by wired and or wireless sources, risk data to be assessed; assessing, by a risk assessment engine, wherein the risk assessment engine identifies and assesses risks to a user and provides a quantified risk and a risk assessment to a risk manager for identification of additional risk; managing risk, by the risk mix manager, wherein the risk mix manager provides COA options to reduce risk; and generating, by the risk assessment engine, COA based at least in part on risk, distance, and cost to the user. The course of action generator including estimating, by the risk assessment engine, a quantitative impact of the risk. The course of action generator including monitoring and reporting the quantitative risk. Wherein a probability and an impact are used to develop a risk-score. Wherein a high-risk score relates to a lower probability of survival at a lower cost. Wherein a low-risk score relates to a higher probability of survival at a higher cost.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a block diagram of one embodiment of an automated mixed course of action (COA) generation system.

FIG. 2 is a functional example showing a system generating a course of action based on mixed risk.

FIG. 3 is a block diagram illustrating an example of system for automatically generating a mixed-risk course of action (COA)in accordance with an embodiment of the present disclosure.

FIG. 4 is a flow block diagram illustrating an example of one method for a mixed course of action (COA) in accordance with an embodiment of the present disclosure.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of Non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

The disclosed mixed risk course of action (COA) system and method of thereof may demonstrate risk-adjusted shortest paths.

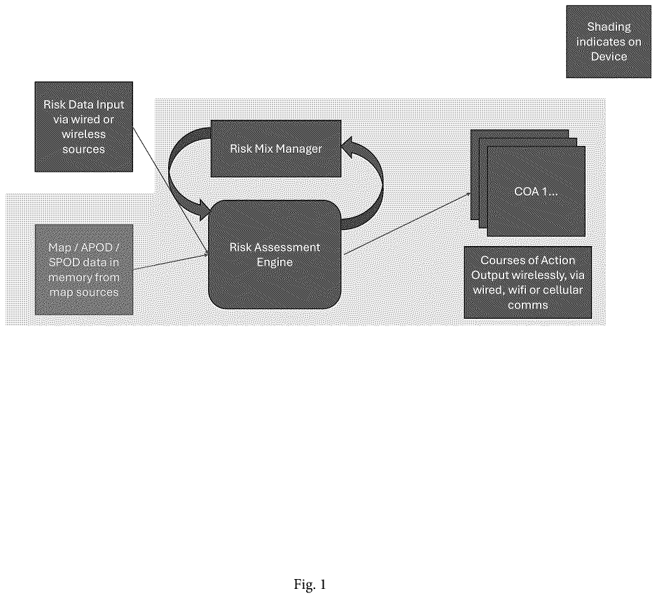

FIG. 1 is a block diagram of one embodiment of an automated mixed course of action (COA) generation system. As shown in FIG. 1, an automated mixed COA system may include one or more risk data input sources, map sources, a risk mix manager, a risk assessment engine, and a COA communications output.

Risk data input sources may include but should not be limited to user sensors, feedback, social media, marketing analysis, user behavior data, government data, and databases.

The risk mix manager may identify, assess, and provide options for reduced risks that could impact a COA.

The risk assessment engine may identify and assess potential risks that could negatively impact the user. The primary purpose is to determine the probability and impact of the identified risks and provide strategies to minimize or avoid the risk. The risk assessment engine may estimate the potential impact of the risk, monitor and report on the risk, and types of risk analysis using qualitative risk and/or quantitative risk analysis.

The COA generation system may provide one or more COA options to a user.

The COA generation system may be a remote system providing one or more outputs to one or more users.

In one embodiment, a risk value may be identified by r=P(E)×I(F), where r is the calculated risk, P(E) is the probability of an event occurring, and is impact severity which may also be referred to as C(I) consequence impact. Consequence impact may relate to survivability.

In one embodiment, P(E) may be a Bayesian probability not only considering the paths but a conditional probability considering conditions unrelated to the shortest distance or probability of survivability of a current user.

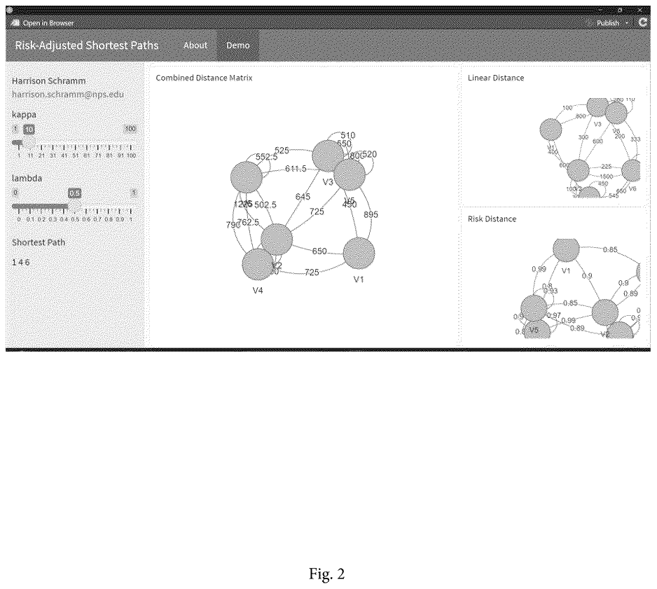

FIG. 2 is a functional example showing a system generating a course of action (COA) based on mixed risk. FIG. 2 shows a 6-node network. The two boxes on the right-hand side of the page show two measures on the same network; the top is the distance in additive units; for example, the distances may be physical distance such as but not limited to miles, costs such as but not limited to money or time. The lower plot may be a risk, such as but not limited to a probability associated with survivability, i.e., 1 is certain survival, and 0 is certain death. The risk-scored distance is shown in the left plot. The risk-score distance may be determined by computing:

COA_{RD}=λLD+(1+λ)κ(−ln(RD))

where LD is the linear distance, RD is the Risk Distance, and λ is a convexity parameter, 0≤λ ≤1. The shortest path may be computed and displayed at the bottom of the input box.

The parameter kappa (κ) may perform the function of consequence expressed in terms of linear distance, thereby transforming risk into units conformable for analysis. κ Probabilities may be unitless, as may their functions. In order to add ‘risk’ to ‘distance’ a parameter κ may be introduced to provide units. Additionally, it may also be used to operationally interpret, ‘“distance,’ or “cost” increases to reduce risk.’ For example, as shown in FIG. 2, a benchmarked 10 miles per 1 percent of risk, so a route that has a 90% probability of survival inherits a 100-mile penalty. The additional “distance” or “cost” may quantify risk for decision-makers. Once κ is set, it may remain for a current analysis or the duration of an exercise/scenario.

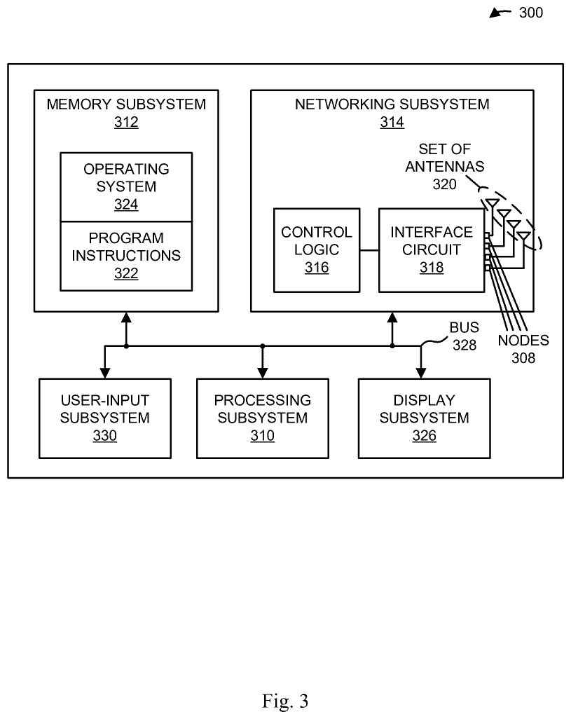

The parameter λ may create a convex combination of risk and distance. Varying λ may produce different solutions to the shortest path routing problem based on time and risk. A low λ value may emphasize speed, while a high λ value may emphasize lower risk. Each solution produced by varying λ may be a unique COA. A mixed COA generation system may have a single COA for all values of λ. Each unique solution for a linear program may create a vector basis, which may be the characteristic of the solution. From an operator's point of view, actions to be taken in the physical world (i.e. logistic plan) may be the same under each basis. In the disclosed system, λ may be a parameter of interest to be varied. By changing λ, ‘breakpoints’ in the underlying solution may be found, each of which represents a unique basis. The break points each represent a unique course of action from an operator's perspective. An operator preferably chooses a course of action based at least in part from the output of the system. FIG. 3 is a block diagram illustrating an example of system for automatically generating a mixed-risk course of action (COA)in accordance with an embodiment of the present disclosure. FIG. 3 presents a block diagram of an electronic device 300 (which may be a mixed COA system, a computer in a computer system, another electronic device, etc.) in accordance with some embodiments. This mixed COA system includes processing subsystem 310, memory subsystem 312, and networking subsystem 314. Processing subsystem 310 includes one or more devices configured to perform computational operations. For example, processing subsystem 310 may include one or more microprocessors, application-specific integrated circuits (ASICs), microcontrollers, programmable-logic devices, one or more GPUs, and/or one or more DSPs.

Memory subsystem 312 includes one or more devices for storing data and/or instructions for processing subsystem 310 and networking subsystem 314. For example, memory subsystem 312 may include dynamic random-access memory (DRAM), static random-access memory (SRAM), a read-only memory (ROM), flash memory, and/or other types of memory. In some embodiments, instructions for processing subsystem 310 in memory subsystem 312 include one or more program modules or sets of instructions (such as program instructions 322 or operating system 324) that may be executed by processing subsystem 310. For example, a ROM may store programs, utilities, or processes to be executed in a non-volatile manner, and DRAM may provide volatile data storage and may store instructions related to the operation of mixed COA system 300. Note that one or more computer programs may constitute a computer-program mechanism, a computer-readable storage medium, or software. Moreover, instructions in the various modules in memory subsystem 312 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 310. In some embodiments, one or more computer programs are distributed across a network-coupled computer system so that they are stored and executed in a distributed manner.

In addition, memory subsystem 312 may include mechanisms for controlling access to the memory. In some embodiments, memory subsystem 312 includes a memory hierarchy that comprises one or more caches coupled to a memory in mixed COA system 300. In some of these embodiments, one or more of the caches may be located in processing subsystem 310.

In some embodiments, memory subsystem 312 may be coupled to one or more high-capacity mass-storage devices (not shown). For example, memory subsystem 312 may be coupled to a magnetic or optical drive, a solid-state drive, or another type of mass-storage device. In these embodiments, memory subsystem 312 may be used by mixed COA system 300 as fast-access storage for often-used data, while the mass-storage device may be used to store less frequently used data.

Networking subsystem 314 includes one or more devices configured to couple to and communicate on a wired and/or wireless network (i.e., to perform network operations), including: control logic 316, an interface circuit 318 and a set of antennas 320 (or antenna elements) in an adaptive array that may be selectively turned on and/or off by control logic 316 to create a variety of optional antenna patterns or ‘beam patterns.’ (While FIG. 3 includes set of antennas 320, in some embodiments mixed COA system 300 includes one or more nodes, such as nodes 308 (which are sometimes referred to as ‘antenna nodes’), e.g., a pad or a connector, which may be coupled to set of antennas 320. Thus, mixed COA system 300 may or may not include set of antennas 320.) For example, networking subsystem 314 may include a Bluetooth networking system, a Bluetooth Low Energy networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

In some embodiments, networking subsystem 314 includes one or more radios, such as a wake-up radio that may be used to receive wake-up frames and wake-up beacons, and a main radio that may be used to transmit and/or receive frames or packets during a normal operation mode. The wake-up radio and the main radio may be implemented separately (e.g., using discrete components or separate integrated circuits) or in a single integrated circuit.

Networking subsystem 314 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments, a ‘network’ or a ‘connection’ between the mixed COA systems does not yet exist. Therefore, mixed COA system 300 may use the mechanisms in networking subsystem 314 for performing simple wireless communication between the mixed COA systems, e.g., transmitting advertising or beacon frames and/or scanning for advertising frames transmitted by other mixed COA systems.

Within mixed COA system 300, processing subsystem 310, memory subsystem 312, and networking subsystem 314 are coupled together using bus 328 that facilitates data transfer between these components. Bus 328 may include an electrical, optical, and/or electro-optical connection that the subsystems may use to communicate commands and data among one another. Although only one bus 328, is shown for clarity, different embodiments may include a different number or configuration of electrical, optical, and/or electro-optical connections among the subsystems.

In some embodiments, mixed COA system 300 includes a display subsystem 326 for displaying information on a display, which may include a display driver and the display, such as a liquid-crystal display, a multi-touch touchscreen, etc. Display subsystem 326 may be controlled by processing subsystem 310 to display information to a user (e.g., information relating to incoming, outgoing, or an active communication session).

Mixed COA system 300 may also include a user-input subsystem 330 that allows a user of the mixed COA system 300 to interact with mixed COA system 300. For example, user-input subsystem 330 may take a variety of forms, such as: a button, keypad, dial, touch screen, audio input interface, visual/image capture input interface, input in the form of sensor data, etc.

Mixed COA system 300 may be (or may be included in) any mixed COA system with at least one network interface. For example, mixed COA system 300 may include: a COA system, a MIO (Multiplexed Input/Output) multiplexer, a cellular telephone or a smartphone, a tablet computer, a laptop computer, a notebook computer, a personal or desktop computer, a netbook computer, a media player device, an electronic book device, a MiFi® device, a smartwatch, a wearable computing device, a portable computing device, a consumer-mixed COA system, an access point, a router, a switch, communication equipment, test equipment, a drone, a type of aircraft, a missile, as well as any other type of mixed COA system having wireless communication capability that may include communication via one or more wireless communication protocols.

Although specific components are used to describe mixed COA system 300, in alternative embodiments, different components and/or subsystems may be present in mixed COA system 300. For example, mixed COA system 300 may include one or more additional processing subsystems, memory subsystems, networking subsystems, and/or display subsystems. Additionally, one or more of the subsystems may not be present in mixed COA system 300. Moreover, in some embodiments, mixed COA system 300 may include one or more additional subsystems that are not shown in FIG. 3. Also, although separate subsystems are shown in FIG. 3, in some embodiments, some or all of a given subsystem or component may be integrated into one or more of the other subsystems or components in mixed COA system 300. For example, in some embodiments, program instructions 322 are included in operating system 324, and control logic 316 may be included in interface circuit 318.

Moreover, the circuits and components in mixed COA system 300 may be implemented using any combination of analog and/or digital circuitry, including: bipolar, PMOS, and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which may sometimes referred to as a ‘communication circuit’) may implement some or all of the functionality of networking subsystem 314. This integrated circuit may include hardware and/or software mechanisms that are used for transmitting wireless signals from mixed COA system 300 and receiving signals at mixed COA system 300 from other mixed COA systems. Aside from the mechanisms herein described, radios are generally known in the art and hence are not described in detail. In general, networking subsystem 314 and/or the integrated circuit may include any number of radios. Note that the radios in multiple-radio embodiments function in a similar way to the described single-radio embodiments.

In some embodiments, networking subsystem 314 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism may be used to switch the radio from monitoring and/or transmitting on a given communication channel to monitoring and/or transmitting on a different communication channel. (Note that ‘monitoring’ as used herein comprises receiving signals from other mixed COA systems and possibly performing one or more processing operations on the received signals).

One embodiment may utilize machine learning to leverage data analysis by identifying patterns, which may allow for automated adjustments and improvements based on historical data and feedback loops, such as but not limited to including techniques like hyperparameter tuning, model selection, and data preparation to fine-tune algorithms and achieve optimal performance on a given task.

One embodiment may include one or more databases that continuously update the system to automatically generate a mixed-risk COA system.

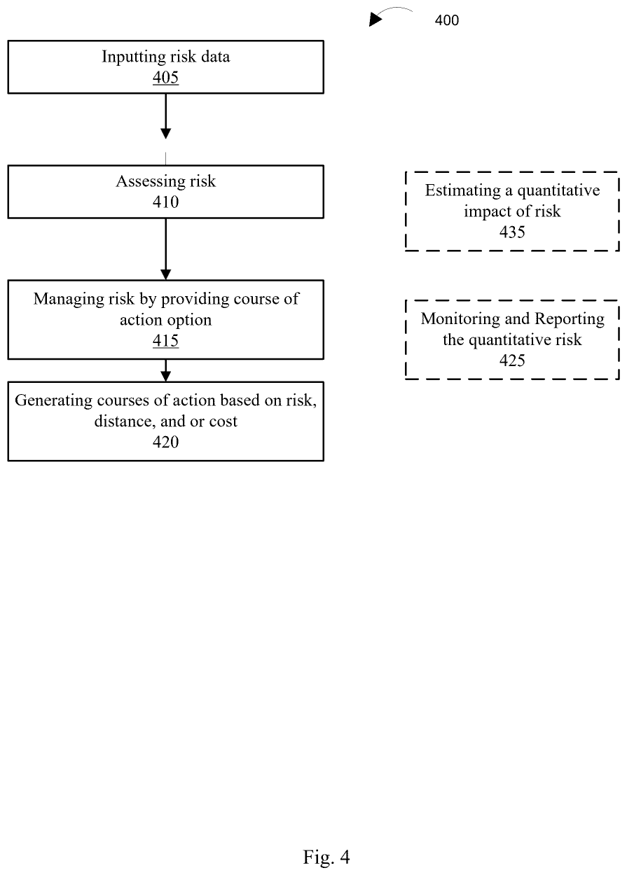

FIG. 4 is a flow block diagram illustrating an example of one method for a mixed course of action (COA) in accordance with an embodiment of the present disclosure.

A method of providing the shortest risk-based path comprising: inputting, by one or more wired and or one or more wireless sources, risk data to be assessed; assessing, by a risk assessment engine, wherein the risk assessment engine identifies and assesses risks to a user and provides a quantified risk and a risk assessment to a risk manager for identification of additional risk; managing risk, by the risk mix manager, wherein the risk mix manager provides one or more COA options to reduce risk; and generating, by the risk assessment engine, one or more COA based at least in part on risk, distance, and cost to the user.

An alternate embodiment of the method may include estimating, by the risk assessment engine, a quantitative impact of the risk.

An alternate embodiment of the method may include monitoring and reporting the quantitative risk. Wherein a probability and an impact are used to develop a risk-score. Wherein a high-risk score relates to a lower probability of survival at a lower cost. Wherein a low-risk score relates to a higher probability of survival at a higher cost.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A risk based shortest course of action generator comprising:
a risk mix manager configured to identify and assess risks, wherein the risk mix manager provides one or more options to a risk assessment engine; and
the risk assessment engine being configured to accept one or more risk data and map source data inputs;
wherein a set of options are produced based at least in part on potential options;
wherein the risk assessment engine and the risk mix manager continuously update each other with risks and risk evaluations;
wherein the risk assessment engine outputs one or more courses of action (COA).

2. The risk based shortest path generator of claim 1, wherein the risk assessment engine determines a risk-score distance for each COA as determined by:
COA_{RD}=λLD+(1+λ) κ (−ln(RD))
where LD is a linear distance, RD is a risk distance, λ is a convexity parameter, 0≤λ ≤1, and κ is the risk distance.

3. The risk based shortest path generator of claim 1, wherein each of the one or more COA provides a different shortest distance based at least in part on a risk-score.

4. The risk based shortest path generator of claim 1, wherein each of the one or more COA provides an increased distance based at least in part on a greater probability of survivability.

5. The course of action generator of claim 1, further comprising one or more breakpoints;
wherein the one or more breakpoints are based at least in part on risk and distance.

6. The course of action generator of claim 5, wherein the breakpoints are a course of action.

7. A course of action generator comprising a non-transitory computer readable medium storing instruction for execution by a processor, wherein the instructions comprise:
inputting, by one or more wired and or one or more wireless sources, risk data to be assessed;
assessing, by a risk assessment engine, wherein the risk assessment engine identifies and assesses risks to a user and provides a quantified risk and a risk assessment to a risk manager for identification of additional risk;
managing risk, by the risk mix manager, wherein the risk mix manager provides one or more COA options to reduce risk; and
generating, by the risk assessment engine, one or more COA based at least in part on risk, distance, and cost to the user.

8. The course of action generator of claim 7, further comprising: estimating, by the risk assessment engine, a quantitative impact of the risk.

9. The course of action generator of claim 7, further comprising: monitoring and reporting the quantitative risk.

10. The course of action generator of claim 7, wherein a probability and an impact are used to develop a risk-score.

11. The course of action generator of claim 10, wherein a high-risk score relates to a lower probability of survival at a lower cost.

12. The course of action generator of claim 10, wherein a low-risk score relates to a higher probability of survival at a higher cost.

13. The course of action generator of claim 7, further comprising one or more breakpoints; wherein the one or more breakpoints are based at least in part on risk and distance.

14. The course of action generator of claim 7, wherein the breakpoints are a course of action.

15. A method of providing the shortest risk-based path comprising:
inputting, by one or more wired and or one or more wireless sources, risk data to be assessed;
assessing, by a risk assessment engine, wherein the risk assessment engine identifies and assesses risks to a user and provides a quantified risk and a risk assessment to a risk manager for identification of additional risk;
managing risk, by the risk mix manager, wherein the risk mix manager provides one or more COA options to reduce risk; and
generating, by the risk assessment engine, one or more COA based at least in part on risk, distance, and cost to the user.

16. The course of action generator of claim 15, further comprising: estimating, by the risk assessment engine, a quantitative impact of the risk.

17. The course of action generator of claim 15, further comprising: monitoring and reporting the quantitative risk.

18. The course of action generator of claim 15, wherein a probability and an impact are used to develop a risk-score.

19. The course of action generator of claim 17, wherein a high-risk score relates to a lower probability of survival at a lower cost.

20. The course of action generator of claim 17, wherein a low-risk score relates to a higher probability of survival at a higher cost.
